(19) United States
(12) Patent Application Publication
(10) Pub. No.: US 2004/0246718 A1
(43) Pub. Date: Dec. 9, 2004

(54) Rope light with flashing portions

(76) Inventor: Pang Hong Fan, Haitzu City (TW)

Correspondence Address: PANG HONG FAN, 15TH FLOOR - D, NO. 81, SEC. 1, HSINTAI 5TH ROAD, HSITZU CITY, TAIPEI HSIEN, TW

(21) Appl. No.: 10/457,214

(22) Filed: Jun. 9, 2003

(51) Int. Cl. F21S 13/14

(52) U.S. Cl. 362/236; 362/235; 362/240; 362/244; 362/245; 362/252; 362/391; 362/806

(57) ABSTRACT

A ropelight having an outer jacket; an inner core; and at least two circuits in the inner core, the at least two circuits having a plurality of bulbs electrically coupled thereto; a controller for controlling at least one of the at least two circuits; a power cable; a connector for electrically coupling the controller to the power cable, the connector being coupled to the controller; and a housing protecting the controller and the connector; and wherein the bulbs of at least one circuit are constantly on; and the bulbs of at least one circuit are flashed or dimmed at a predetermined interval.

### BACKGROUND

This application relates to a lamp, and more particularly to a controller and connector for a rope light.

Rope lights on the market currently have single loop, double loop, triple loop or quadruple loop circuit versions. Regular rope lights are powered up when plugged into a power source, and usually do not flash or dim. Other rope lights are coupled to controllers to generate flashing, chasing, or jumping effects. However, controllers are expensive, and in certain applications not every part of the decorative light needs to flash. For example, the decorative effect could well be sufficient if a part of the light is constantly on, and another part periodically flashes or dims.

Frequently, controller boxes are bulky, making the controller boxes prone to tangling with surrounding objects such as other wires. Moreover, many controller boxes are heavy, making it difficult to hang a ropelight. Additionally, controller boxes have typically been exposed to air, which may lead to an electrocution hazard for adults and children in particular.

There is therefore a need for a rope light, having a controller that overcomes these shortcomings.

### SUMMARY OF THE INVENTION

Accordingly, the present invention is directed to a power cable for a ropelight. The power cable has a controller for controlling at least a portion of the ropelight and a connector for electrically coupling the ropelight to a power source, the connector being coupled to the controller. The power cable also has a housing protecting the controller and the connector.

The present invention is also directed to a ropelight connectable to a power cable, the ropelight having at least two circuits, a plurality of bulbs electrically coupled to the at least two circuits, a controller for controlling at least one of the at least two circuits, a connector for electrically coupling the ropelight to the power cable, the connector being coupled to the controller, and a housing protecting the controller and the connector.

The present invention is also directed to a ropelight having an outer jacket; an inner core; at least two circuits in the inner core, the at least two circuits having a plurality of bulbs electrically coupled thereto; a controller for controlling at least one of the at least two circuits; a power cable; a connector for electrically coupling the controller to the power cable, the connector being coupled to the controller; and a housing protecting the controller and the connector. The bulbs of at least one circuit are constantly on; and the bulbs of at least one circuit are flashed or dimmed by the controller at a predetermined interval.

### DRAWINGS

These and other features, aspects and advantages of the present invention will become better understood with regard to the following description, appended claims and accompanying drawings, where:

FIG. 1 is a side elevational view of a ropelight and a connectable power cable having a controller according to a preferred embodiment of the present invention;

FIG. 2 is a partially cut away view of the power cable of FIG. 1;

FIG. 3 is an exploded view of a controller of the current invention;

FIG. 4 is a side elevational view of a power cable connectable to a ropelight according to a second embodiment of the present invention;

FIG. 5 is a side elevational view of a ropelight having a controller and a connectable power cable according to a third embodiment of the present invention;

FIG. 6 is a side elevational view of a ropelight with an inline controller and power connector according to a fourth embodiment of the present invention;

FIG. 7 is a schematic view of the circuitry of a rope light according to a preferred embodiment of the present invention;

FIG. 8 is a schematic view of the circuitry of a rope light according to a first alternative embodiment of the present invention;

FIG. 9 is a schematic view of the circuitry of a rope light according to a second alternative embodiment of the present invention; and

FIG. 10 is a side elevational view of a ropelight of the present invention formed into a decorative configuration.

### DETAILED DESCRIPTION

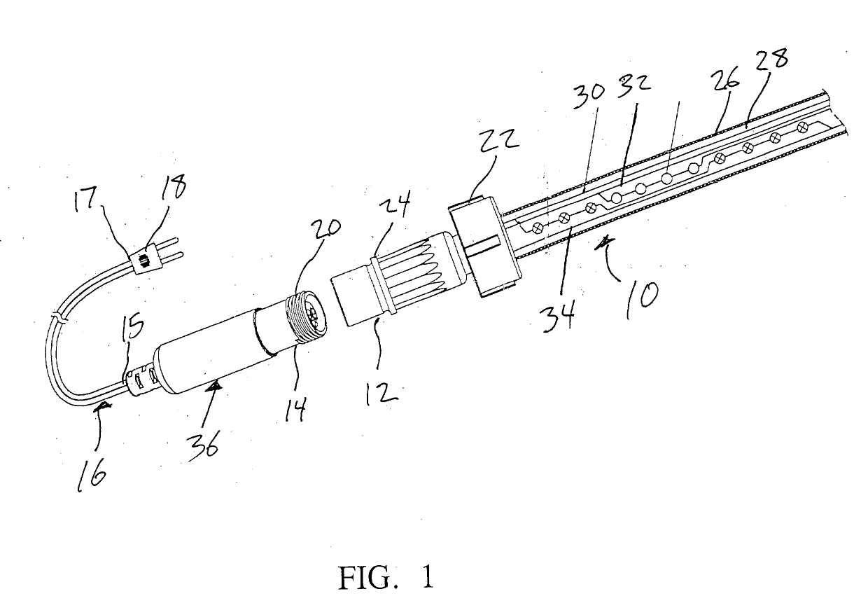

A ropelight 10 according to the present invention may either be formed having a two piece power connector, or an in-line power connector that is not separable. An example of a rope light having a two piece power connector is shown in FIG. 1. As shown in FIG. 1, a rope light connector 12 is located at an end of the rope light 10. The rope light connector 12 is connectable to a power cable connector 14 at a first end 15 of a power cable 16. A second end 17 of the power cable 16 is coupled to a plug 18 for placement in an electrical outlet.

As shown in FIG. 1, the rope light connector 12 and the power cable connector 14 are held together via outer threads 20 on the power cable connector 14 and a rotatable cap 22 mounted on the rope light connector 12. The rotatable cap 22 has a shoulder (not shown) that is held against a lip 24 on the rope light connector 12. The rotatable cap has internal threads (not shown) that thread onto the outer threads 20 of the power cable connector 14 to hold the power cable connector 14 to the rope light connector 12.

An outer diameter of at least a portion of the rope light connector 12 is smaller than an inner diameter of the power cable connector 14. The rope light connector 12 may fit inside the power cable connector 14 during coupling of the rope light 10 to the power cable 16. In a version of the present invention, one or more washers (not shown) may be used to further seal the rope light 10 to the power cable 16.

One skilled in the art will recognize that the coupling arrangement may be reversed with the outer threads being on the rope light connector and the rotatable cap being mounted on the power cable connector. Additionally, one skilled in the art will recognize that alternative coupling means may be employed to join the power cable connector to the rope light connector.

In a preferred embodiment of the present invention, as shown in FIG. 1, the rope light 10 includes an outer jacket 26, an inner core 28, a first wire 30, a second wire 32, and a third wire 34. The wires 30, 32, 34 form at least two separate circuits. At least one of the at least two separate circuits is controlled by the controller to flash or dim.

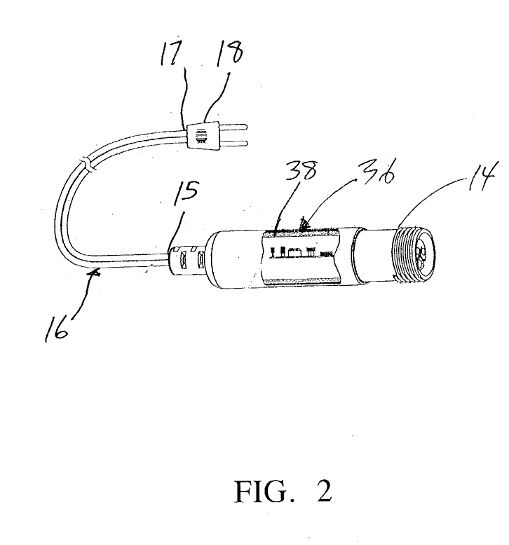

In a preferred embodiment, as shown in FIGS. 1 and 2, a controller 36 is formed together with the power cable connector 14 as a single piece molded in a plastic housing 38 onto the power cable 16. The power cable connector 14 is connectable to the rope light connector 12. The power cable of FIG. 1 may be used with existing ropelights having multiple circuits.

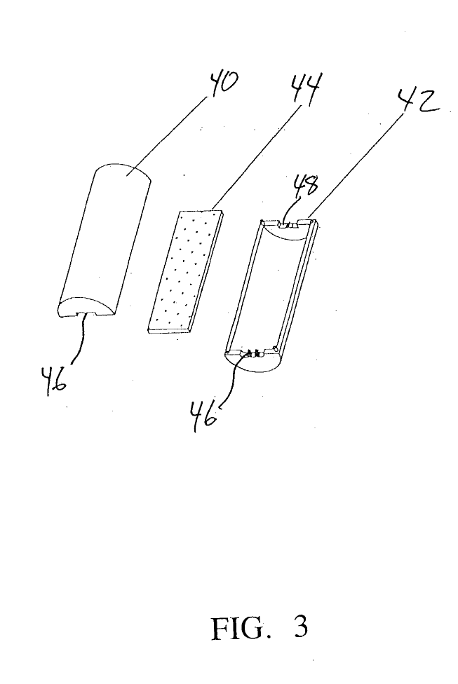

As shown in FIG. 3, the housing 38 may be formed from two half shells 40, 42, with a control circuit 44 inside the half shells 40, 42. The half shells 40 and 42 may contain openings 46, 48 for insertion of portions of the power cord 16. The half shells 40, 42 may be fastened to each other with fasteners such as screws. Alternatively, the half shells 40, 42 may be snap fitted together to allow for replacement of the control circuit 44. Additionally, the half shells 40, 42 may be glued to each other. In an embodiment, the housing 38 is waterproof.

Preferably, housing 38 is cylindrical with a diameter of less than 2 inches, and more preferably less than 1 inch. The small size of the housing 38 makes the controller 36 less obtrusive and less attractive to pets and children. The small size of the housing 38 prevents the controller from getting tangled in nearby objects, such as other wires.

Preferably, the controller 36 requires no adjustment by a user and is therefore very simple to operate. Additionally, the compact combination controller and connector is very efficient to produce and thereby may reduce the cost of production of the rope light.

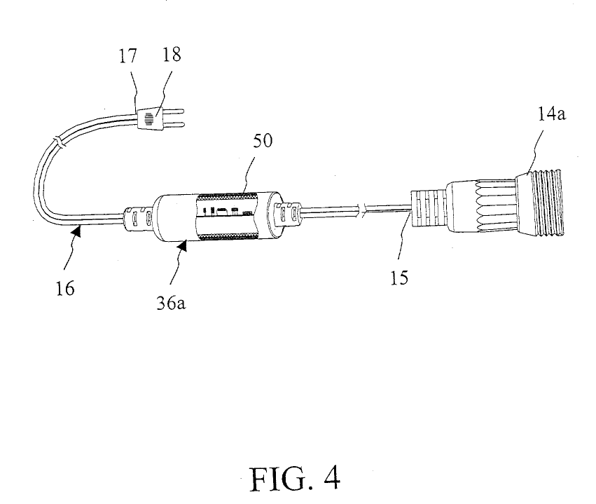

In a second embodiment of the present invention, shown in FIG. 4, a power cable connector 14a is coupled to the first end 15 of the power cable 16. A plug 18 for connection to an electrical outlet is coupled to the second end 17 of the power cable 16. The power cable connector 14a may be connected to the ropelight connector 12 on the ropelight 10. A controller 36a in a separate housing 50 is positioned between the first end 15 and the second end 17 of the power cable 16.

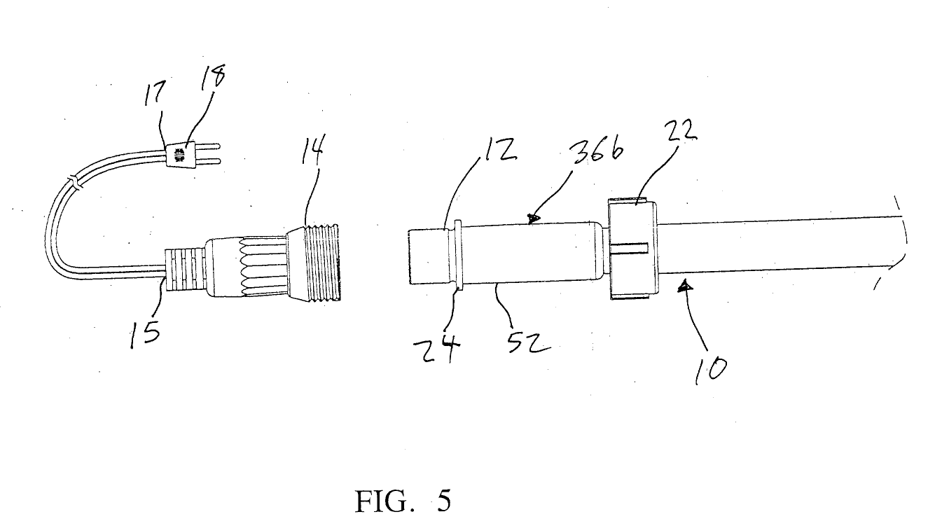

In a third embodiment of the present invention, shown in FIG. 5, a ropelight 10 has a controller 36b formed integrally with the ropelight connector 12 as a single piece molded in a plastic housing 52 onto the ropelight. The ropelight connector 12 may be connected to the power cable coupling connector 14 on the power cable 16. Additionally, the controller and connector may be housed within the outer jacket 26 of the ropelight 10.

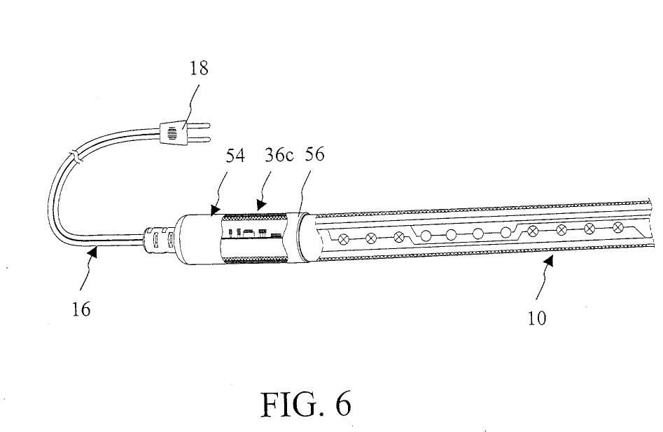

In a fourth embodiment of the present invention, shown in FIG. 6, a ropelight 10 has a controller 36c formed integrally with a connector 54 in the rope light as a single piece molded in a plastic housing 56. In the fourth embodiment, the connector is a single piece rather than two connectable pieces.

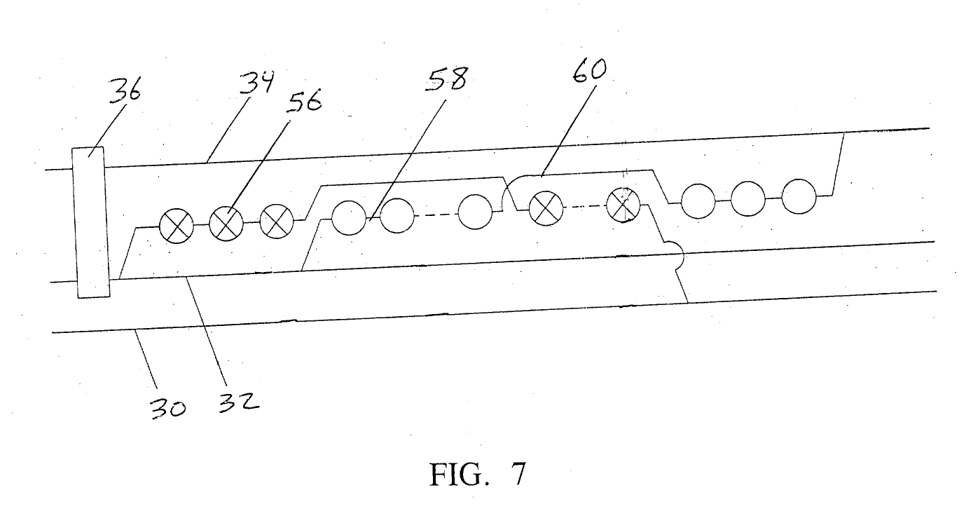

As shown in FIG. 7, each circuit in the rope light has electrically installed thereon one or more bulbs 56, inside the rope light core 28. The controller 36 controls the bulbs 56 on at least one circuit. Different types of controllers are known in the art for causing bulbs to flash or for varying the intensity of bulbs coupled to the controller at predetermined intervals.

In a preferred embodiment, as shown in FIG. 7, the first wire 30 and the second wire 32 form a first circuit 58. The second wire 32 and the third wire 34 form a second circuit 60. The controller 36 is electrically coupled to both the first circuit 58 and the second circuit 60. The bulbs on the first circuit 58 and the bulbs on the second circuit 60 may be in alternate positions inside the rope light 10.

In the preferred embodiment, shown in FIG. 7, the controller may control the second wire 32 to adjust the current in both the first and second circuits 58, 60. By varying the current in both the first and second circuits 58, 60, the controller causes the bulbs attached to both the first and second circuits to blink or dim in unison. Additionally, the controller 36 may adjust the current in the third wire 34 to adjust only the current in the second circuit 60. By varying the current in the second circuit 60 alone, the controller may flash or dim the bulbs attached to the second circuit 60, while the bulbs attached to the first circuit 58 remain constantly on.

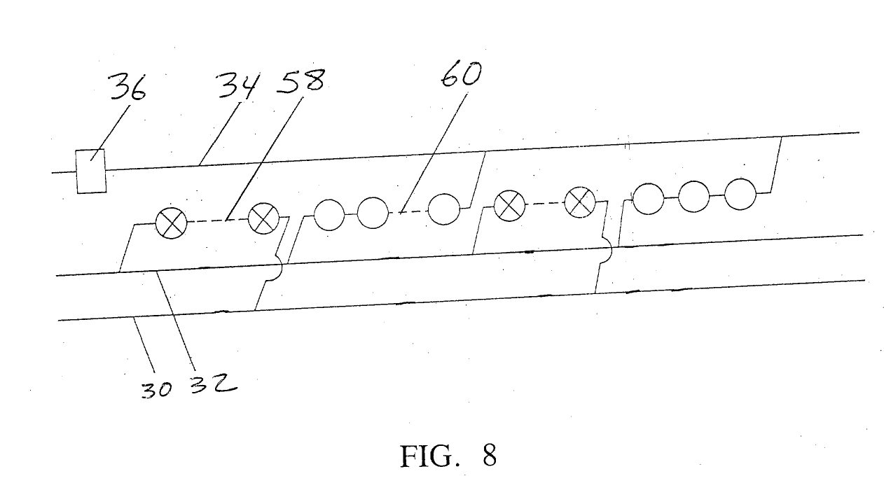

In a first alternative embodiment of the circuitry in the ropelight, as shown in FIG. 8, the controller 36 only controls the current in the third wire 34 to adjust the current in the second circuit 60, thereby flashing or dimming the bulbs attached to the second circuit. The current in the first and second wires 30, 32 remains constant, thereby providing constant power to the bulbs coupled to the first circuit 58.

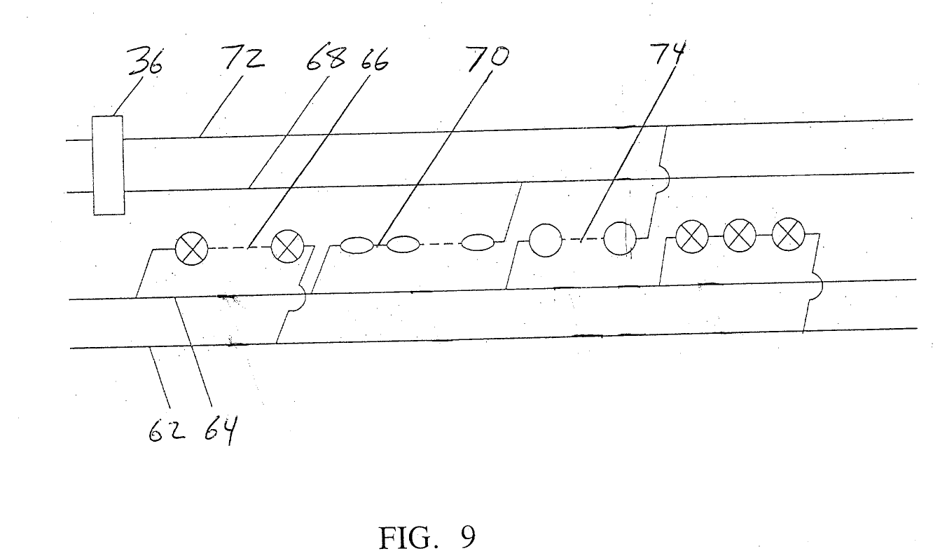

The invention can be applied to a rope light 10 having more than 2 circuits. In a second alternative embodiment of the circuitry, as shown in FIG. 9, there are four wires forming three circuits. A first wire 62 and a second wire 64 form a constant circuit 66 having bulbs connected thereto. The second wire 64 and a third wire 68 form a first variable circuit 70 having bulbs connected thereto. The third wire 68 and a fourth wire 72 form a second variable circuit 74 having bulbs connected thereto.

The controller 36 controls the current in the third wire 68 and the fourth wire 70 to separately flash or dim the bulbs on the first and second variable circuits. The bulbs on the three circuits 66, 70, and 74 can be alternately installed inside the body of the rope light.

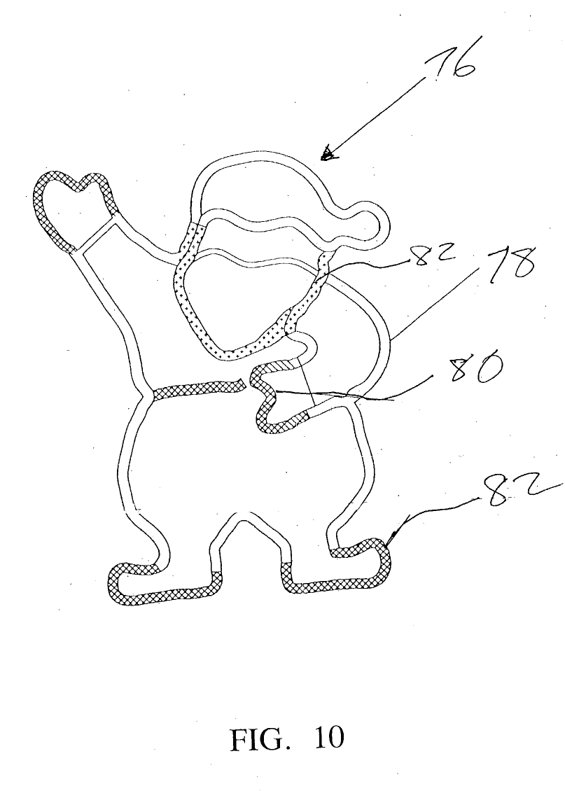

Therefore, the invention can be applied according to the visual effects desired, to provide a combination of portions that are constantly lit and portions that flash or change intensity. FIG. 10 shows a Santa Claus 76 formed of the rope light 10 of the current invention. Portions of the Santa Claus 76, for example, the trunk portion 78, are constantly lit. Additionally, other portions of the Santa Claus 76, such as the hands 80 and feet 82, are wired on a first variable circuit to flash or dim. Yet other portions of the Santa Claus, such as the beard 82, are wired on a second variable circuit to flash or dim.

Although the present invention has been described in considerable detail with reference to certain preferred versions thereof, other versions are possible. Therefore, the spirit and scope of the appended claims should not necessarily be limited to the description of the preferred versions contained herein.

All features disclosed in the specification, including the claims, abstracts and drawings, and all the steps in any method or process disclosed, may be combined in any combination except combination where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

1. A power cable for a ropelight, the power cable comprising:
a controller for controlling at least a portion of the ropelight;
a connector for electrically coupling the ropelight to a power source, the connector being coupled to the controller; and
a housing protecting the controller and the connector.

2. The power cable of claim 1 wherein the housing is waterproof and further comprises molded plastic.

3. The power cable of claim 1 wherein the housing is a cylinder having a diameter of less than 2 inches.

4. The power cable of claim 3 wherein the housing is a cylinder having a diameter of less than 1 inch and wherein the housing comprises two plastic shells coupled together.

5. The power cable of claim 1 wherein the controller is configured to dim bulbs on at least a portion of the ropelight at a predetermined interval.

6. The power cable of claim 1 wherein the controller is configured to flash bulbs on at least a portion of the ropelight at a predetermined interval.

7. A rope light coupled to the power cable of claim 1.

8. A ropelight connectable to a power cable, the ropelight comprising:
at least two circuits;
a plurality of bulbs electrically coupled to the at least two circuits;
a controller for controlling at least one of the at least two circuits;
a connector for electrically coupling the ropelight to the power cable, the connector being coupled to the controller; and
a housing protecting the controller and the connector.

9. The ropelight of claim 8 wherein the housing is waterproof and further comprises molded plastic.

10. The ropelight of claim 8 wherein the housing is a cylinder having a diameter of less than 2 inches.

11. The ropelight of claim 10 wherein the housing further comprises two plastic shells coupled together.

12. The ropelight of claim 8 wherein the controller is configured to dim the bulbs on at least one of the at least two circuits at a predetermined interval.

13. The ropelight of claim 8 wherein the controller is configured to flash the bulbs on at least one of the at least two circuits at a predetermined interval.

14. The ropelight of claim 8 further comprising:
a first circuit; and
a second circuit; and
wherein the controller is configured to flash at least one of the first circuit and the second circuit at a predetermined interval.

15. The ropelight of claim 8 further comprising:
a first circuit; and
a second circuit; and
wherein the controller is configured to dim at least one of the first circuit and the second circuit at a predetermined interval.

16. The ropelight of claim 8 further comprising:
a first circuit; and
a second circuit; and
wherein the controller is configured to dim one of the first and second circuits at a first predetermined interval and to blink the other of the first and second circuits at a second predetermined interval.

17. The ropelight of claim 8 further comprising:
a first circuit;
a second circuit; and
a third circuit; and
wherein the controller is configured to dim or flash the first circuit at a first predetermined interval and to dim or flash the second circuit at a second predetermined interval.

18. The rope light of claim 8 wherein the controller is formed by molding as an integral part of the rope light.

19. A ropelight comprising:
an outer jacket;
an inner core;
at least two circuits in the inner core, the at least two circuits having a plurality of bulbs electrically coupled thereto;
a controller for controlling at least one of the at least two circuits;
a power cable;
a connector for electrically coupling the controller to the power cable, the connector being coupled to the controller; and
a housing protecting the controller and the connector; and
wherein the bulbs of at least one circuit are constantly on; and the bulbs of at least one circuit are flashed or dimmed by the controller at a predetermined interval.

20. The rope light of claim 19 wherein the controller is formed as an integral part of the power cable connector.

21. The rope light of claim 20 wherein the controller further comprises:
two half shells; and
a control circuit inside the half shells.

22. The rope light of claim 21 wherein the controller further comprises:
two half shells; and
a control circuit inside the half shells.
